(19) United States
(12) Patent Application Publication
(10) Pub. No.: US 2011/0167029 A1
(43) Pub. Date: Jul. 7, 2011

(54) METHOD AND DEVICE FOR CLASSIFYING, DISPLAYING AND EXPLORING BIOLOGICAL DATA

(75) Inventor: Sebastien Raimbault, Argelliers (FR)

(73) Assignee: HORIBA ABX SAS, MONTPELLIER (FR)

(21) Appl. No.: 13/060,501

(22) PCT Filed: Aug. 5, 2009
(86) PCT No.: PCT/FR2009/051559

§ 371 Date: Feb. 24, 2011

(30) Foreign Application Priority Data
Sep. 5, 2008 (FR) 08 55986

(51) Int. Cl. G06N 5/02

(52) U.S. Cl. 706/46

(57) ABSTRACT

The invention provides a method for use in an automated biological liquid analysis machine that measures at least four physical parameters for each cell detected, the method both performing classification, by discrimination and enumeration, into a set of at least three cell classes and also representing them. In this method, the following are stored and executed as required: mathematical transformations for transforming a plurality of n-tuples into m-tuples, m<n, each transformation enabling the cell classes of a biological liquid presenting average statistical characteristics to be placed into distinct zones of an m-dimensional composite space, filters for discrimination and for re-classification into at least two cell classes, and at least one transformation for transforming a plurality of n-tuples into 3-tuples, 2-tuples, or 1-tuples, to display the cell classes of a biological liquid presenting average statistical characteristics in distinct zones of a 3-dimensional space, a 2-dimensional surface, or a one-dimensional axis.

### BACKGROUND OF THE INVENTION

The present invention relates to the general field of the analysis of biological liquids, and more particularly to the field of automated machines for analyzing biological liquids.

More precisely, the invention provides methods of classifying cell populations by enumeration and discrimination by processing data such as that from a device for analyzing biological liquid. Such a method is intended to be used in an automated analysis machine.

The possibility of analyzing a large number of structures on a cellular or sub-cellular scale is of considerable interest to fundamental research, whether for drug studies or as a diagnostic tool. The systematic analysis of a large number of biological cells means that the biology can be accessed via statistics, i.e. one or more of the cell properties are studied in a large number of cells.

Flow cytometry is a technique that is adapted to the statistical study of cellular populations, since cells are studied one by one in a sample of several hundred or thousand cells.

By means of suitable cell preparation, generally carried out by introducing a dye or a fluorescent agent, more generally known as a “molecular probe”, information relating to those cells is made accessible to the biologist. In particular, this relates to the determination of the intracellular contents such as DNA, RNA, proteins, ionic species, or hemoglobin content. The use of molecular probes associating an antibody and a luminophore on the surface antigen principle means that specific functions located on the surface of the cell membranes can be revealed.

The principles of flow cytometry are as follows. The microscopic objects to be analyzed are transported along a liquid path to the focusing point of a light beam, generally a laser. Detectors are positioned along specific sighting axes in order to collect interaction signals between light and particle.

A first detector placed in the vicinity of the axis of the incident laser beam measures diffraction at small angles: in general, it is dimensioned so as to be sensitive to low spatial frequencies, i.e. to the volume of the particle and its refractive index. The direct laser beam that has not interacted with that particle is blocked by a mask.

Other detectors may be placed at 90° to the axis of the incident beam. The light detected is analyzed into one or more spectral components corresponding to the fluorescent or diffracted light.

Electrical measurements are also carried out, such as a measurement of resistivity using the electronic gate principle that is well known to the skilled person. That technique is, for example, detailed in the article by Volker Kachel: “Electrical Resistance Pulse Sizing: Coulter Sizing” in Flow Cytometry and Sorting, Second Edition, 1990, Wiley-Liss, Inc Editor, p 45-80.

In principle, an electronic gate consists in causing each biological cell to pass through a very small orifice. A constant current passes through that orifice with an intensity that is modulated by the variation in electrical resistance induced by the passage of the particle through said orifice. That signal is approximately proportional to the volume of the cell. The electronic gate may also be supplied with an alternating current, in accordance with document U.S. Pat. No. 4,791,355.

Hematology analyzers also comprise an optical channel for measuring the absorbance of a particle passing through a measuring cell.

The aim of a hematological analyzer, for example, is to count the various cells present in a blood sample, to differentiate those cells and thus to be able to determine the proportion of each of the cell classes relative to the whole sample.

In the vast majority of cases, interpreting measurements from a cell counter operating on whole blood and for enumeration and differentiation of cell populations requires a graphical representation in the form of a two-dimensional matrix.

To this end, the populations that are represented are identified with two physical parameters that are either optical or electrical, or both. Specifically with the LMNE matrix, which is the standard representation of leukocyte sub-populations on HORIBA ABX instruments (5DIFF analysis), the two measurements used are absorbance and resistivity. That matrix is termed the LMNE matrix because it allows differentiation and enumeration of Lymphocytes, Monocytes, Neutrophils and Eosinophils, i.e. the populations of white cells, or leukocytes, normally present in the blood.

That representation means that the majority of populations of white cells can be visualized, but that graphical visualization only takes into account two physical parameters obtained from the analyzer.

In new generations of analyzers, it is possible to obtain more physical parameters such as, for example, small angle diffraction, also known as forward scatter (FSC), diffusion at 90°, also known as side scatter (SSC), a fluorescence pathway with thiazole orange as the reagent, denoted FL1 and finally the resistivity, denoted RES. It is also possible to envisage other fluorescences with an antibody labeled with a fluorochrome as the reagent, for example.

Currently, when more than two variables are measured per cell or particle, visualization on a two-dimensional screen is traditionally carried out by selecting two variables. That thus consists in making a projection orthogonally to the plane of those two variables.

However, depending on the elements observed and on the measurements available, such orthogonal projections are not always suitable for visualization and automatic discrimination of the classes of the elements.

U.S. Pat. No. 6,630,990 filed by Abbott, “Optical method and apparatus for red blood cell differentiation on a cell-by-cell basis, and simultaneous analysis of white blood cell differentiation” proposes projecting data onto a three-dimensional space and is based on Mie's model for determining the concentration of hemoglobin, the maturity, and the shape of the red cells of a sample.

U.S. Pat. No. 6,944,338 from Becton Dickinson & Co, “System for identifying clusters in scatter plots using smoothed polygons with optimal boundaries” generates two-dimensional histograms based on density in order to discriminate populations.

U.S. Pat. No. 6,662,117 from Sysmex Corp, “Particle analyzer and particle classifying method” describes the use of a matrix based on the variance and co-variance of the characteristics of the cells to be discriminated.

The treatment uses two-dimensional histograms to carry out a classification.

International patent application WO 2006/015056 from Dako Cytomation, “ENHANCING FLOW CYTOMETRY DISCRIMINATION WITH GEOMETRIC TRANSFORMATION”, describes sorting two types of particle in real time by means of linear data processing.

None of the above-mentioned documents thus describes a method or device that can manage a large amount of data available per cell and that is capable of carrying out an automatic classification into at least three classes of cells. Further, none of the documents describes a treatment that can produce a visualization on a single screen of all of the cell classes present in a sample, with differentiation and enumeration of those cells. The methods described also cannot be used to isolate, for example, certain abnormal cells of a particular cell class.

### OBJECT AND SUMMARY OF THE INVENTION

Thus, the principal aim of the present invention is to overcome such disadvantages by proposing a method for use in an automated biological liquid analysis machine that can detect cells in the liquid and that can determine an n-tuple comprising at least four physical parameters (n>3) for each detected cell, said method being intended both for performing classification, by discrimination and enumeration, into at least one set of cell classes, and also for representing them, the classification and representation advantageously being adapted to the detection of pathological signature(s) and comprising the following steps:

a) initially, storing a plurality of mathematical transformations T for transforming a plurality of n-tuples into m-tuples, m<n, each transformation, associated with a particular classification of n-tuple elements within a predetermined set of cell classes and determined as a function of statistical knowledge about cells constituting said cell classes, enabling the cell classes of a biological liquid presenting the average statistical characteristics to be placed into distinct zones of the m-dimensional composite space, the plurality of stored transformations advantageously allowing various placements of cell classes to be obtained that are appropriate to particular discriminations for use in indicating pathologies;

b) initially storing a plurality of filters for discrimination and reclassification into at least two cell classes to allow the m-tuples from at least two cell classes to be discriminated in the m-dimensional composite spaces;

c) initially storing, for display, at least one transformation of a plurality of n-tuples into 3-tuples, into 2-tuples, or into 1-tuples determined as a function of statistical knowledge about cells constituting the cell classes of a normal biological liquid, enabling the cell classes of a biological liquid presenting the average statistical characteristics to be placed into distinct zones of a 3-dimensional space, or of a 2-dimensional surface, or of a one-dimensional axis;

d) receiving a plurality of n-tuples as results of the analysis of a biological liquid;

e) associating a first arbitrary classification with the received n-tuples;

f) selecting a subset of n-tuples as a function of their classes;

g) selecting and applying to the selected n-tuples a transformation T into m-tuples;

h) selecting and applying a discrimination filter to the m-tuples, which entrains updating the classes of the n-tuples;

i) reiterating steps f), g) and h) by selecting a subset of n-tuples and/or a distinct transformation thereof and/or a distinct filter thereof, each iteration defining a step in a discrimination algorithm, said algorithm being defined by the series of applications of transformations and filters, said series advantageously being adapted as a function of the desired signatures;

j) selecting a subset of n-tuples to be displayed as m-tuples as a function of their classes;

k) applying a particular display tag to the n-tuples as a function of their class;

l) applying to the selected n-tuples a transformation into 3-tuples, into 2-tuples, or into 1-tuples; and

m) displaying the result of the transformation into 3-tuples, 2-tuples or into 1-tuples on a screen or on any other display medium, each discriminated cell class being represented by a dynamic two-dimensional, three-dimensional or one-dimensional cloud of points carrying tags.

The term “display medium” means a computer screen, a paper medium, or any other visual representation means, irrespective of whether it is an integral part of the device or remote therefrom.

The term “tag” means a color, an icon, or any other graphical element that can visually separate the n-tuples corresponding to distinct classes or cell classes. The term “dynamic 3D space” means a 3D space displayed on a screen, and thus in two-dimensions, which can be caused to rotate so that it can be observed on the screen from several angles.

The iteration of steps f) to h) corresponds to a multi-step sequence of a “classification” algorithm, each of these steps concerning a set of the classes under consideration and comprising at least one transformation that defines a composite space and a filter for discrimination and reclassification of the observed elements into at least two classes. Each step of the algorithm, one for each pair of cell classes that are to be discriminated, updates the class of each selected particle in the form of a corresponding n-tuple.

The method of the invention offers a more precise discrimination result by incorporating all of the physical parameters measured on the analyzer, for example the following parameters: FSC, SSC, FL1, RES. In particular, and conventionally, the compensation enables the influence of other fluorescences to be subtracted from the intensity of a given fluorescence. This is conventionally used only for fluorescence.

The method of the invention enables signal proportions to be withdrawn or added algorithmically in order to obtain better discrimination of the populations of interest. In particular, this characteristic can be applied to the results of morphological measurements (SSC, FSC, RES, etc).

The invention makes possible a better representation of the sub-populations of white cells in the form of a two-dimensional matrix. In addition to the two-dimensional representation, the invention identifies cells as a function of their maturation and their physical characteristics, nucleus, and cytoplasm, with the guarantee that all of the cell populations are distinct from one another, in order to be able to classify them into cell classes; further, overlap phenomena are small, in particular in the absence of pathologies. This facilitates interpretation by the skilled person.

With the method of the invention, the n input variables are fused to create an m-dimensional composite space. In this space, it is then possible to produce two-dimensional projections that are appropriate for what is to be shown, if necessary after executing appropriate rotations. A zone of interest may then be shaped, especially using zoom or offset functions. The composite space and the shaping are adapted to visualizing on a projection or to automatically discriminating the classes of elements affected by the classification. The discrimination may be carried out by investigating peaks and valleys on a histogram.

The method of the invention has already enabled algorithms for automatic classification of leukocytes to be developed and has provided high performance visualization means for all leukocyte classes or for certain cellular features, for example with a view to detecting several sub-populations of lymphocytes.

The invention uses statistics concerning the physical parameters of the cell classes concerned based on the variance/covariance matrixes defined above. The stored transformations are linear or non-linear.

In accordance with a particular characteristic of the invention, the physical parameters are the values RES, FSC, FL1, and SSC.

The term “value” means the maximum height of the pulse on the RES, FSC, FL1, or SSC channel.

In accordance with an advantageous characteristic of the invention, a functional transformation Tn→m, which may be linear or non-linear, is applied, consisting in transforming the n-dimensional measurement vector (n≧3) into an m-dimensional composite vector, m<n as follows:

F: Rⁿ→R^{m}

X→Y such that yᵢ=fᵢ(X), 0<i<=m

where x is the initial n-dimensional measurement vector, also denoted xi(X1 . . . Xn), and y is the image vector that represents the element yi(Y1 . . . Ym) in the normalized m-dimensional composite vector space.

Advantageously, the functions fi are of the form:

fᵢ(X)=(Aᵢ·X+bᵢ)/(Ci·X+dᵢ)

where Ai (respectively Ci) is the i^{th} row of the matrix A (respectively C) containing m rows and n columns, and bi (respectively di) is the i^{th} element of m-dimensional vector B (respectively D).

The transformation is thus characterized by these two matrixes A and C and these two vectors B and D. If the matrix C is zero and all of the elements of D are non-zero, then the situation is linear.

This characteristic means that it is ensured that the various cell classes are distributed, into distinct zones in the composite space, provided that all of the factors in the matrixes A and C and in the vectors B and D are determined with the aid of statistical knowledge about the cell classes observed in a normal biological liquid.

The transformations in the m-dimensional space are then such that in the presence of normal blood, the clouds of points of the various cell classes are located in distinct zones. It can thus readily be understood that as soon as the biological liquid composition becomes non-normal, for example during a pathology, the distribution into distinct and/or defined zones does not occur and the biological disorder can be highlighted.

In accordance with a particular characteristic of the invention, the application of one particular transformation followed by the application of one particular filter may be repeated in order to refine the discrimination.

In particular, such a repetition is advantageously carried out following other distinct transformations that enable one or more discriminations to be performed in accordance with criteria other than those of said repeated transformation.

In accordance with an advantageous characteristic of the invention, the series of transformations used is associated with a particular classification of a predetermined set of cell classes revealing a pathology, said series being determined as a function of statistical knowledge about cells constituting said cell classes, enabling the cell classes of a biological liquid having the average statistical characteristics of the pathology to be placed into distinct zones of the m-dimensional composite space, the “pathology” transformation meaning that a normal biological liquid can be distinguished from a biological liquid having a particular pathology.

In accordance with a particular characteristic of the invention, the series of transformations used in steps f) and g) and the transformation, in the two or three-dimensional space, is such that the cell classes are classified by degree of maturity.

This means that on glancing at the screen, the presence of abnormal degradation of cells or an abnormality in the maturity of cells present in the biological liquid can be noticed.

The invention also provides a device for classifying, by discrimination and enumeration, into at least one set of three cell classes, the device being for connection to an automated biological liquid analysis machine that can detect cells in the liquid and that is capable of determining an n-tuple comprising at least four physical parameters (n>3) for each detected cell, said device comprising:
a memory for storing:
   a plurality of mathematical transformations T for transforming a plurality of n-tuples into m-tuples, m<n, each transformation, associated with a particular classification of a predetermined set of cell classes and determined as a function of statistical knowledge about cells constituting said cell classes, enabling the cell classes of a biological liquid presenting the average statistical characteristics to be placed into distinct zones of the m-dimensional composite space;
   a plurality of discrimination filters enabling, in the m-dimensional composite spaces, the m-tuples of each cell class of the predetermined set to be discriminated;
   at least one transformation of a plurality of n-tuples into 3-tuples, into 2-tuples or into 1-tuples, determined as a function of statistical knowledge about cells constituting the cell classes of a normal biological liquid, enabling the cell classes of a biological liquid presenting the average statistical characteristics to be placed into distinct zones of a 3-dimensional space, or of a 2-dimensional surface, or of a one-dimensional axis;
means for receiving a plurality of n-tuples resulting from the analysis of a biological liquid;
means for associating a first arbitrary classification to each n-tuple;
means for selecting a subset of n-tuples as a function of their classes;
means for selecting at least one transformation T from the plurality of transformations and at least one discrimination filter from the plurality of discrimination filters;
data processor means for applying at least the selected transformation T and the discrimination filter to the selected n-tuples;
means for selecting a subset of n-tuples as a function of their classes;
data processor means for associating a particular tag with the m-tuples as a function of their class;
data processor means for applying the transformation of the plurality of n-tuples to 3-tuples, 2-tuples or 1-tuples;
means for displaying the result of the transformation into 3-tuples, 2-tuples, or 1-tuples on a screen.

In accordance with a preferred implementation, the various steps of the method of the invention are determined by computer program instructions.

As a consequence, the invention also provides a computer program on an information medium, said program being capable of being executed in a computer, processing hardware such as a FPGA (field programmable gate array) or any other type of programmable electronics, said program comprising instructions adapted to execute the steps of the method of the invention.

This program may use any programming language and may be in the form of source code, machine code, or a code intermediate between source code and machine code, such as in a partially compiled form, or in any other desirable form.

The invention also provides a computer-readable data medium including instructions for a computer program as mentioned above.

The data medium may be any entity or device that is capable of storing the program. As an example, the medium may comprise storage means such as a read only memory (ROM), for example a compact-disk (CD), or a digital video disk (DVD) that may optionally be rewritable, etc, or a microelectronic circuit ROM, or a magnetic recording means, for example a floppy disk, a hard disk, or a non-volatile memory (for example a flash memory, such as a universal serial bus (USB key, etc).

Furthermore, the information support may be a transmission medium such as an electrical or optical signal, which may be conveyed via an electrical or optical cable, by radio, or other means. The program of the invention may in particular be downloaded over an internet type network.

Alternatively, the data medium may be an integrated circuit into which the program is incorporated, the circuit being adapted to execute or be used in executing the method in question.

### BRIEF DESCRIPTION OF THE DRAWINGS

Other characteristic and advantages of the present invention become apparent from the description made below with reference to the accompanying drawings that illustrate an embodiment and are not in any way limiting in nature. In the figures:

FIG. 1 is a diagrammatic representation of a device of the invention;

FIGS. 2a to 2c show results obtained using the method of the invention for a normal blood;

FIG. 3 shows, in the form of blocks, the expected positions of the populations of FIG. 2b;

FIGS. 4a to 4j show the results obtained using the method of the invention for a normal blood (4a) and pathological bloods (4b to 4j).

### DETAILED DESCRIPTION OF AN EMBODIMENT

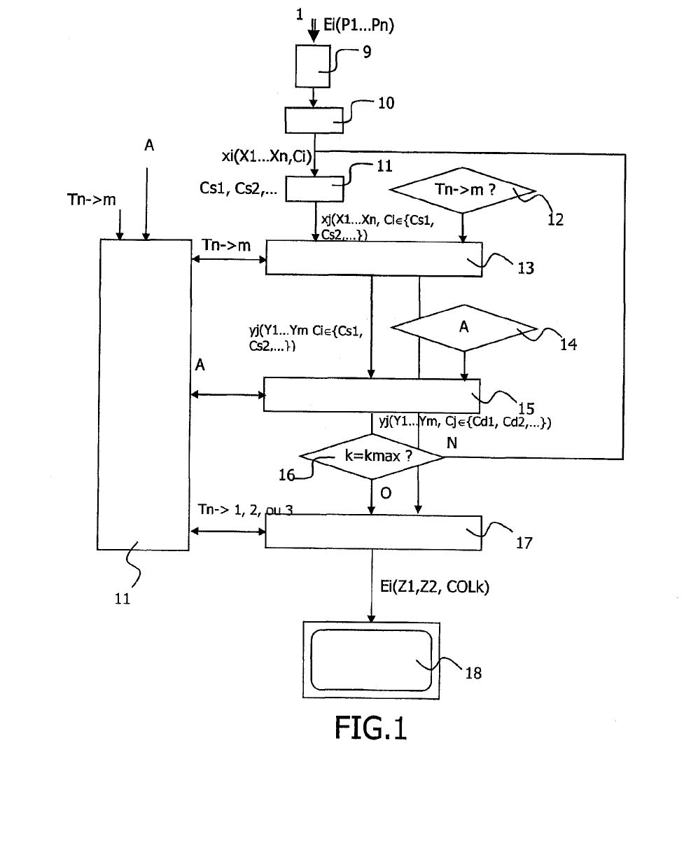

FIG. 1 is a diagrammatic illustration of a device for carrying out the invention. This device comprises receiving means 9 for receiving data from a biological liquid analyzer 1 that can be used to determine n physical parameters X1 to Xn, n>3, per detected cell xi. These n parameters define an n-tuple or measurement vector xi(X1 . . . Xn).

This analyzer is advantageously a flow cytometer and supplies at least four parameters, for example, namely small angle diffraction, denoted X1=FSC below, diffusion at 90°, denoted X2=SSC, at least one fluorescence pathway, denoted X3=FL1, and resistivity, denoted X4=RES. In the particular example described, thiazole orange, which binds to intracellular nucleic acids, is used to reveal nucleated cells, in particular white cells in this example.

Within the arbitrary class attribution means 10, knowledge about these parameters means that an arbitrary class can be attributed to each of the n-tuples. However, since the transformations used do not modify the class Ci associated with each n-tuple, we shall refer below to transformations of an n-dimensional space into an m-dimensional space and continue to make reference to n-tuples.

In the example described, the device comprises means 11 for selecting a group of n-tuples belonging to a subset of classes termed input classes used in the step Csi.

The device comprises a memory 18 that stores the software elements that enable the set of received data xi(X1 . . . Xn, Csi) to be transformed by transformation T into spaces having a plurality of dimensions strictly less than n and, in the example provided, step Cdi makes use of filters A to discriminate subsets of the output cell classes.

The device also comprises means 12 for selecting a transformation Tn→m of a constellation of data in the n-dimensional space into a constellation in an m-dimensional space. According to the invention, each transformation may be associated with one or more particular classifications of a predetermined set of cell classes and may be determined as a function of statistical knowledge about cells constituting the cellular populations corresponding to these cell classes.

The term “particular classification” means any set of cell classes into which the detected cells are to be classified. These classifications differ as a function of the aim of the analysis.

During a simple blood analysis, the first aim is to discern whether the composition of the analyzed blood is within the normal range. The invention can provide access to this information by separating the cell classes to be discriminated for normal blood and it also allows them to be visualized when displayed on a screen.

Another aim is to confirm the features typical of a pathological blood. The typical elements of such a blood for a particular pathology are known in a statistical manner, and so the associated transformation Tn→m enables the corresponding cell classes to be separated when displayed on a screen. Furthermore, the computations obtained can provide a result regarding the pathological condition of the blood under study.

Each transformation thus means that the cell classes of the desired particular classification of a biological liquid presenting average statistical characteristics can be placed into distinct zones of the m-dimensional composite space.

Processor means 13 execute the selected transformation Tn→m on the data set xi(X1 . . . Xn) in order to produce a data set yi(Y1 . . . Ym) in an m-dimensional space.

This functional transformation Tn→m, is linear or non-linear, and consists in transforming the n-dimensional measurement vector (n>3) into an m-dimensional composite vector, <n by a functional transformation:

F: Rⁿ→R^{m}

x→y such that yᵢ=fᵢ(X1 . . . Xn), 0<i<=m

where x is the initial n-dimensional measurement vector, also denoted xi(X1 . . . Xn), and y is the image vector that represents the element yi(Y1 . . . Ym) in the normalized m-dimensional composite vector space.

Advantageously, the functions fi are of the form:

fᵢ(x)=(Aᵢ·x+bᵢ)/(Ci·x+dᵢ)

where Ai (respectively Ci) is the i^{th} row of the matrix A (respectively C) containing m rows and n columns, and bi (respectively di) is the i^{th} element of vector B (respectively D) with dimension m.

The transformation is thus characterized by the two matrixes A and C and the two vectors B and D. If the matrix C is zero and all of the elements of D are non-zero, then the situation is linear.

Other types of stored transformation advantageously allow two parameters associated with the same cell to be multiplied, the aim being to reduce the number m of dimensions of the composite space to the minimum necessary to achieve the aim.

The cell classes that are to be discriminated are thus placed in the m-dimensional space in the form of a plurality of constellations that are separate from each other.

Means 14 for selecting discrimination filters can then select the filter A for the step in progress. It should be understood that each step is defined by a selection filter—a subset of classes—, a transformation, and a discrimination filter that re-classifies the m-tuples in the composite space into a subset of classes. The selection may be manual, carried out by a user, or pre-programmed and thus automatic. In the processor means 15, these filters A are then used to observe the constellations allowing the best discriminations between the cells of several distinct populations. A certain number of cell discriminations are then carried out in the m-dimensional space. For each step, the choice of filter is associated with the choice of the transformation Tn→m that was previously executed. One or more filters may be used with the same transformation. Similarly, the same filter may be used after two distinct transformations.

The same filters and transformations may also act on the subsets of distinct selected n-tuples.

The set formed by the selection of a subset of n-tuples (or n+1-tuples since one class is properly associated with the n-tuple), the selection and application of a transformation and the selection and application of one or more filter(s) constitutes a step in the discrimination algorithm used in accordance with the invention. The set of steps, each using a selection of n-tuples, a transformation, and at least one filter constitutes the discrimination algorithm proper at the end of which all of the cells are associated with one of the classes that are to be discriminated.

Advantageously, a principle of repeating the population-correction steps may be carried out. A first initial classification is carried out by a procedure for selecting predetermined zones.

In an illustrative example, each step uses a transformation of each measurement vector into a space with dimension m=1; each measurement vector is then reduced to a single value. A filter for discrimination for a subset of classes is then applied. Only the vectors having an initial classification belonging to the subset of selected vectors are considered.

Advantageously, the separation or reclassification boundaries are previously set, and thus stored or determined by means of histograms using previously established, statistical criteria.

In the various steps, appropriate transformations, filters, and class results are used, these operations together defining a discrimination algorithm as defined in the invention.

Once the step of the algorithm in question has been applied, a control module 16 checks whether all of the intended steps have been carried out. If this is not so, another algorithm step is carried out. If this is so, then the set of n-tuples is sent to the processor means 17.

The classification carried out by the discriminations associates a different graphical distinction COLk to each cell class Ck that is to be discriminated, for example a point color or a point shape. This produces a set of points yi(Y1 . . . Ym, COLk) in the m-dimensional space corresponding to a set of points xi(X1 . . . Xn, COLk) in the n-dimensional space.

Finally, these processor means 17 apply a transformation Tn→1, Tn→2, or Tn→3 to change the set of points xi(X1 . . . Xn, COLk) into a composite vector set Ei(Z1, Z2, COLk) in a two-dimensional or three-dimensional space. The result is then a distribution of cell classes into colored plane or three-dimensional constellations. The transformation Tn→1, Tn→2 or Tn→3 is such that when the biological liquid has the average characteristics of a normal blood, the cloud of points has little or no overlap when the points Ei(Z1, Z2, COLk) are displayed on the display means 19 either in a planar manner, in which case, for one dimension, it is possible to make use of channel density in order to represent the histogram, or by using a dynamic 3D space. This is not the case with the orthogonal two-dimensional projections that are generally used.

This two-dimensional display on a screen allows the user to obtain information very rapidly since the transformation into an m-dimensional space followed by the transformation into a two-dimensional space are selected having regard to the question to be answered: for example, is the blood normal? or does the blood show a given pathology? etc.

An essential point of the invention is that the plurality of transformations stored in accordance with the invention in a memory of the device of the invention makes it possible to produce matrixes that are more appropriate to each envisaged question.

In general, in the invention, three steps are necessary in order to obtain a two-dimensional representation of four physical parameters X1, X2, X3, X4 in accordance with the invention.

In addition to the prior association with an arbitrary class, the first step 1 consists in applying a transformation of the measured data X1, X2, X3, X4 constituting the n-tuple associated with each cell in order to obtain, for each cell, the coordinates Y1, Y2 and Y3 as a function of the measured values of X1, X2, X3 and X4 and three constants that are dependent upon the calibration of the measurement set-up and of the acquisition system.

Next, in a second step 2, a filter is applied and the subset of points that belong to the classes that are to be displayed is selected.

The third step consists in applying a transformation of the n-tuples to a one, two, or three-dimensional space, here a two-dimensional space for display. For each of these points, now denoted Ei, two coordinates Z1 and Z2 are then associated with each cell with, for example, a color COLk corresponding to the class Ck determined by means of the classification.

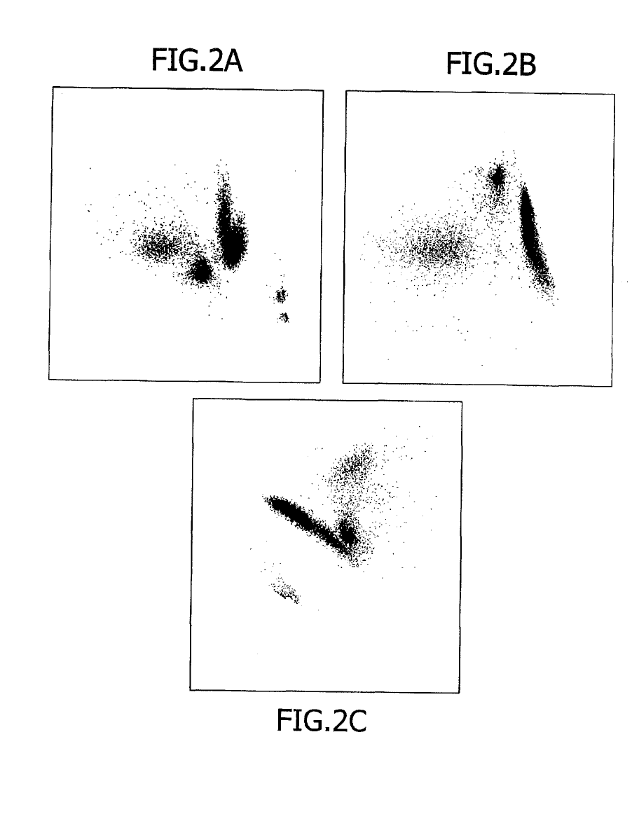

FIG. 2 shows three examples of the results of such transformations in a two-dimensional space, meaning that cell classes can be specifically visualized as a function of analysis requirements. FIG. 2A is one of these representations and is described below. FIG. 2B corresponds to another transformation for preferential visualization of the maturation states of cell lines, and is also described below. FIG. 2C shows a preferential visualization of lymphoid line pathologies, in particular chronic lymphoid leukemia (CLL).

In one implementation of the invention, the available transformations are advantageously used successively on the same set of points xi(X1 . . . Xn).

Thus, a first transformation can answer a basic question: is the blood normal or not?

If the user observes that the clouds of points are not separate, there may be a technical problem or a pathology. At the same time the user has access to an enumeration of the cells of each cell class as well as to their relative proportions.

Further, even if the cell classes, for example stained with different colors, overlap in the final representation obtained, it is possible to come to a decision regarding the blood. The classification has been carried out using different transformations, in spaces that are not those displayed in 2D. Thus, the separation may be exact, even if the cell populations are projected over one another in the visualization plane.

It is interesting to note that it is possible to elect to mask certain cell classes that are not germane to the analysis in order to simplify the display, or to reveal certain particular characteristics.

Under such circumstances, or if the proportional or enumeration values are not normal, or if a particular alarm has been triggered by the preceding algorithm, the method may be recommenced with a transformation associated with a particular classification that corresponds, for example, to a particular pathology or to a particular age of the patient.

The new transformation generates a set of points in an m-dimensional space that may be similar to or different from that appropriate for the first transformation employed. In this transformation corresponding to a particular classification, the populations of cells to be looked at in more detail are similar or, more generally, they are different from those being classified during the first transformation.

The transformations include linear and/or non-linear computations that allow the best possible representation of the results to be obtained from an angle that is favorable to providing access to the desired information. This angle is associated with the pathology to be revealed from the acquired raw data.

The invention can also use interactive exploration means.

Thus, as presented above, a transformation in a composite space with a dimension m=3 is used. The transformation Tn→m and the filter subset are adapted to the observation, for example of a cell line, a family of pathologies, or something else.

Conventional 3D geometrical elements including rotations, affinities, etc may then be employed as the secondary transformations in order to observe anomalies by projection over the sub-varieties and/or to reclassify the measurement vectors. If the transformation Tn→m is linear, it is easy to aggregate these secondary transformations with the primary transformation Tn→m in order to produce a new transformation T′.

In this implementation, four physical measurements are thus obtained from a blood analyzer in the form of four physical parameters: X1, X2, X3, X4, respectively corresponding to small angle diffraction, diffusion at 90°, a fluorescence route with thiazole orange as the reagent, and resistivity.

An example of such a transformation, as shown in FIG. 2A, which can be used to change a 4D measurement space wherein the measurements available for each cell are the parameters X1, X2, X3, X4, into a composite 2D space, is defined by the following equations:

Y1=C11·X1+C12·X2+C13·X3+C14·X4+C15

Y2=C21·X1+C22·X2+C23·X3+C24·X4+C25

This transformation allows all of the populations of a normal blood to be visualized and enables numerous lymphoid line pathologies to be detected. The constants C1i and C2i are defined as a function of the characteristics of the analyzer, in particular those of the optical bench.

As an example, C11=0.1431, C12=0.1496, C13=−0.8895, C14=−0.1261, C15=4155, C21=−0.3713, C22=0.0279, C23=−0.0877, C24=0.7925 and C25=682.8.

FIG. 5 shows, in the form of two-dimensional surfaces, the various populations observed in a normal type blood and in pathological bloods with the transformation as disclosed above.

The invention renders it possible to visualize five leukocyte populations comprising basophils. The types of representations shown in these figures are examples to give an idea of the disposition of the various leukocyte populations in accordance with the invention as a function of pathological or non-pathological blood samples.

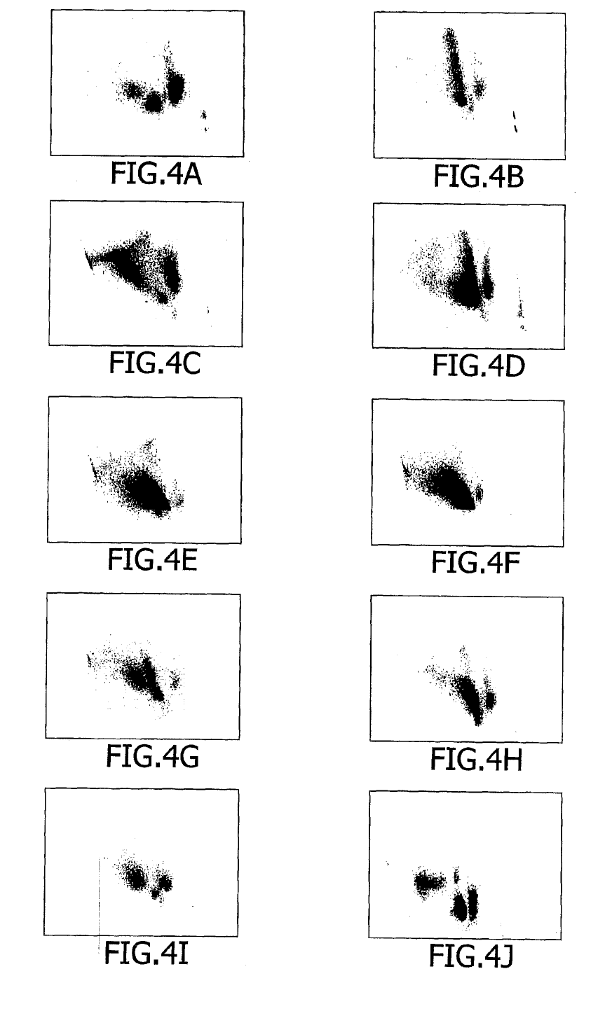

FIG. 4A corresponds to a normal blood. FIG. 4B corresponds to a blood indicating tricholeukocyte leukemia. FIG. 4C corresponds to a blood indicating a myeloma. FIG. 4D corresponds to a blood indicating a Sezary syndrome. FIGS. 4E and 4F correspond to bloods indicating an ALL (acute lymphoid leukemia) type B2 leukocyte leukemia. FIG. 4G corresponds to a blood indicating a Burkitt ALL/B3 ALL leukemia. FIG. 4H corresponds to a blood indicating T ALL. FIG. 4I corresponds to a blood indicating AML (acute myeloid leukemia) leukemia. FIG. 4J corresponds to a blood indicating a CLL (chronic lymphoid leukemia) pathology.

In another example, the result of such a transformation is a representation such as that shown in FIG. 2B.

In the proposed example, the values for the factors are thus:

$$A = ( \begin{matrix}- 1551 & 0 & 0 & 0 \\ 0 & - 100 & 0 & 0 \\ - 100 & 0 & 0 & 0\end{matrix} )$$

$$B = ( \begin{matrix}6351345 \\ 409500 \\ 409500\end{matrix} )$$

$$C = ( \begin{matrix}0 & 0 & 1 & 0 \\ 0 & 0 & 0 & 1 \\ 0 & 1 & 0 & 0\end{matrix} )$$

$$D = ( \begin{matrix}1 \\ 1 \\ 1\end{matrix} )$$

The second step 2 consists of a graphical transformation containing a translation and a rotation matrix (Euler matrix) such that the angles of rotation in this example are 130°, 51° and 209° about a center located at (2048, 2048, 2048).

The following equations are thus obtained:

Y′1=[0.1161*(Y1−2048)−0.91899*(Y2−2048)−0.37677(Y3−2048)]+2048

Y′2=[−0.92118*(Y1−2048)−0.24152*(Y2−2048)+0.30510(Y3−2048)]+2048

Y′3=[−0.37138*(Y1−2048)+0.31163*(Y2−2048)−0.87461(Y3−2048)]+2048

The third step 3 consists of a graphical adaptation in order to optimize the visualization of the families of cells in a 4096×4096 graphical representation such that:

Y″1=Y′1*3−10500

Y″2=Y′2

The final equations into which the set of steps are integrated are thus:

Y(1=540.6*(4095−X1)/(1+X3)−275.7*(4095−X2)/(1+X4)−113.04*(4095−X1)/(1+X2)+2892; and

Y(2=−1429*(4095−X1)/(1+X3)−24.15*(4095−X2)/(1+X4)+30.51*(4095−X1)/(1+X2)+3805.

In order for X and Y to be represented as being in the range 0 to 4095, the saturation limits may be added:

If X<0 then X=0

If X>4095 then X=4095

If Y<0 then Y=0

If Y>4095 then Y=4095

The representation of the cell classes obtained in this matrix form enable all of the leukocyte sub-populations present in the whole blood sample to be viewed at once. The sub-populations are visible and well separated and there is little overlap between the various populations except for abnormal bloods. In the representation obtained in FIG. 2B, the abscissa and the ordinate axes do not have a definite direction. In contrast, the disposition of the populations on the matrix is large.

With the equation presented above, the positions on the two-dimensional space of the cell classes are ordered up the vertical (ordinate axis) starting with the most immature cells, followed by the mature cells; in the horizontal direction (abscissa axis) it breaks down into cells with a mono-nucleated structure and those with a polynucleated structure.

This representation resembles the classification tree diagram for blood cells starting from stem cells. It allows the physician or biologist to make an easier and more direct interpretation of the various leukocyte sub-populations.

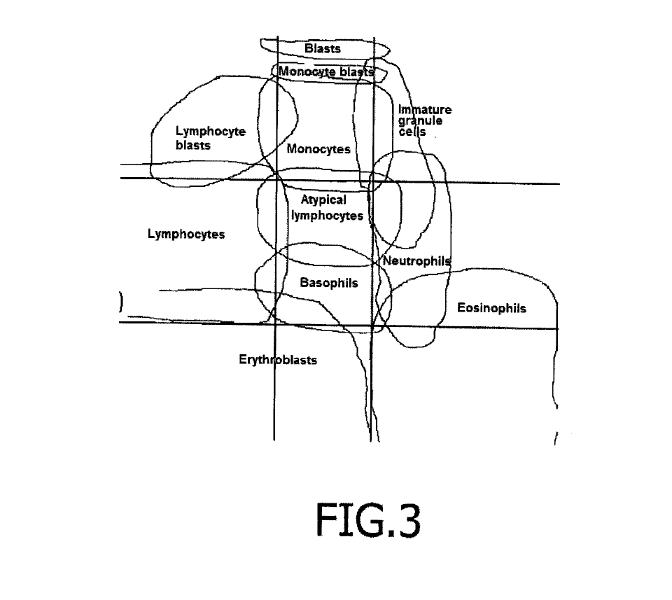

FIG. 3 is a diagrammatic representation of the distinct zones into which it is possible to place the various populations of leukocytes that are assumed to be observed in the two-dimensional matrix described above. The presence or otherwise of the populations on the screen depends on the bloods being analyzed, being normal or abnormal/pathological.

Finally, it should be noted that a variety of implementations is encompassed within the principles of the invention. In particular, different forms of representation of the leukocyte populations in the form of sets of constellations can be accessed by the invention.

What is claimed is:

1. A method for use in an automated biological liquid analysis machine that can detect cells in the liquid and that can determine an n-tuple comprising at least four physical parameters measured for each detected cell, said method being intended both for performing classification, by discrimination and enumeration, into a set of at least three cell classes, and also for representing them, and comprising the following steps:
a) initially, storing a plurality of mathematical transformations for transforming a plurality of n-tuples into m-tuples), m<n, each transformation, associated with a particular classification of n-tuple elements within a predetermined set of cell classes and determined as a function of statistical knowledge about cells constituting said cell classes, enabling the cell classes of a biological liquid presenting the average statistical characteristics to be placed into distinct zones of the m-dimensional composite space;
b) initially, storing a plurality of filters for discrimination and reclassification into at least two cell classes to allow the m-tuples from at least two cell classes to be discriminated in the m-dimensional composite spaces;
c) initially, storing, for display, at least one transformation of a plurality of n-tuples into 3-tuples, 2-tuples, or 1-tuples determined as a function of statistical knowledge about cells constituting the cell classes of a normal biological liquid, enabling the cell classes of a biological liquid presenting the average statistical characteristics to be placed into distinct zones of a 3-dimensional space, a 2-dimensional surface, or of a one-dimensional axis;
d) receiving a plurality of n-tuples as results of the analysis of a biological liquid;
e) associating a first arbitrary classification with the received n-tuples;
f) selecting a subset of n-tuples as a function of their classes;
g) selecting and applying to the selected n-tuples a transformation into m-tuples;
h) selecting and applying a discrimination filter to the m-tuples, which entrains updating the classes of the n-tuples;
i) reiterating steps f), g) and h) by selecting a subset of n-tuples and/or a distinct transformation thereof and/or a distinct filter thereof, each iteration defining a step in a discrimination algorithm, said algorithm being defined by the series of applications of transformations and filters;
j) selecting a subset of n-tuples to be displayed as m-tuples as a function of their classes;
k) applying a particular display tag to the n-tuples as a function of their class;
l) applying to the selected n-tuples a transformation into 3-tuples, or 2-tuples, or into 1-tuples; and
m) displaying the result of the transformation into 3-tuples or 2-tuples on a screen or on any other display medium, each discriminated cell class being represented by a dynamic two-dimensional or three-dimensional cloud of points carrying tags.

2. The method according to claim 1, wherein the physical parameters are RES, FSC, FL1 and SSC.

3. The method according to claim 2, wherein the transformation of n-tuples to 2-tuples associates with each cell a composite vector of the form
Y1=C11·FSC+C12·SSC+C13·FL1+C14·RES+C15 and Y2=C21·FSC+C22·SSC+C23·FL1+C24·RES+C25.

4. The method according to claim 1, wherein at least certain steps of the discrimination algorithm are repeated in order to refine the discrimination.

5. The method according to claim 1, comprising a step of storing a transformation termed “pathology” of a plurality of
n-tuples to m-tuples, m<n, associated with a particular classification of a predetermined set of cell classes revealing the pathology and determined as a function of statistical knowledge about cells constituting said cell classes, enabling the cell classes of a biological liquid presenting the average statistical characteristics of the pathology to be placed into distinct zones of the m-dimensional composite space, the pathology transformation allowing a normal biological liquid to be dissociated from a biological liquid having a particular pathology.

6. The method according to claim 1, wherein the transformation of n-tuples into 2-tuples enables the cell classes of a biological liquid presenting the average statistical characteristics of the pathology to be placed into distinct zones of the composite 2-dimensional space.

7. The method according to claim 1, wherein the transformation into the two-dimensional space is such that the cell classes are classified by degree of maturity.

8. The method according to claim 1, wherein the transformation of n-tuples into 3-tuples enables the cell classes of a biological liquid presenting the average statistical characteristics of the pathology to be placed into distinct zones of a dynamic composite 3-dimensional space on the display.

9. A device for classifying, by discrimination and enumeration, into a set of at least three cell classes, the device being for connection to an automated biological liquid analysis machine that can detect cells in the liquid and that is capable of determining an n-tuple comprising at least four physical parameters for each detected cell, said device comprising:
a memory for storing:
a plurality of mathematical transformations for transforming a plurality of n-tuples into m-tuples, m<n, each transformation, associated with a particular classification of a predetermined set of cell classes and determined as a function of statistical knowledge about cells constituting said cell classes, enabling the cell classes of a biological liquid presenting the average statistical characteristics to be placed into distinct zones of the m-dimensional composite space;
a plurality of filters for discrimination and re-classification into at least two cell classes enabling, in the m-dimensional composite spaces, the m-tuples of at least two cell classes to be discriminated;
for display, at least one transformation of a plurality of n-tuples into 3-tuples, 2-tuples or 1-tuples, determined as a function of statistical knowledge about cells constituting the cell classes of a normal biological liquid, enabling the cell classes of a biological liquid presenting the average statistical characteristics to be placed into distinct zones of the 3-dimensional space, or of a 2-dimensional surface, or of a one-dimensional axis;
means for receiving a plurality of n-tuples resulting from the analysis of a biological liquid;
means for associating a first arbitrary classification to each n-tuple;
means for selecting a subset of n-tuples as a function of their classes;
means for selecting at least one transformation from the plurality of transformations and at least one discrimination filter from the plurality of discrimination filters;
data processor means for applying at least the selected transformation and the discrimination filter to the selected n-tuples and for reiterating said applications;
means for selecting a subset of n-tuples to be displayed as m-tuples, as a function of their classes;
data processor means for associating a particular tag with the m-tuples as a function of their class;
data processor means for applying the transformation of the plurality of n-tuples to 3-tuples, 2-tuples or 1-tuples;
means for displaying the result of the transformation into 3-tuples, 2-tuples or 1-tuples on a screen.

10. A computer program intended for use by a computer, processing hardware such as a FPGA or any other type of programmable electronics, comprising instructions for executing the steps of the method according to claim 1 when said program is executed by a computer.

11. A computer-readable recording medium having recorded thereon a computer program comprising instructions for executing the steps of the method according to claim 1 is recorded.
